(19) United States
(12) Patent Application Publication
(10) Pub. No.: US 2012/0254035 A1
(43) Pub. Date: Oct. 4, 2012

(54) PORTABLE ELECTRONIC DEVICE WITH SPENDING DETECTING FUNCTION AND SPENDING DETECTING METHOD

(75) Inventor: PENG WANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/196,909

(22) Filed: Aug. 3, 2011

(30) Foreign Application Priority Data
Apr. 2, 2011 (CN) 201110083964.3

(51) Int. Cl. G06Q 40/00

(52) U.S. Cl. 705/44

(57) ABSTRACT

A portable electronic device with a spending detecting function is provided. The portable electronic device stores a predetermined expense value. The portable electronic device detects a current expense of the portable electronic device periodically or in a predetermined condition. The portable electronic device determines whether the current expense of the portable electronic device is greater than the predetermined expense value stored in the data storage, and is prevented from paying the current expense if the current expense of the portable electronic device is greater than the predetermined expense value stored in the data storage.

### BACKGROUND

1. Technical Field

The present disclosure relates to a portable electronic device with a spending detecting function and a spending detecting method.

2. Description of Related Art

With developments of the electronic technology, the user can add an amount of money to a portable electronic device, such as a cell phone, to pay calling fees, network fees, or other bills. However, if the portable electronic device is lost and the loss is not reported in time, the amount of money added to the portable electronic device may be spent by others in a short period of time, thus increasing the losses of the user.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an exemplary embodiment of a portable electronic device with a spending detecting function.

FIG. 2 is a flowchart of a spending detecting method applied to the portable electronic device as shown in FIG. 1, in accordance with a first exemplary embodiment.

FIG. 3 is a flowchart of a spending detecting method applied to the portable electronic device 1 as shown in FIG. 1, in accordance with a second exemplary embodiment.

### DETAILED DESCRIPTION

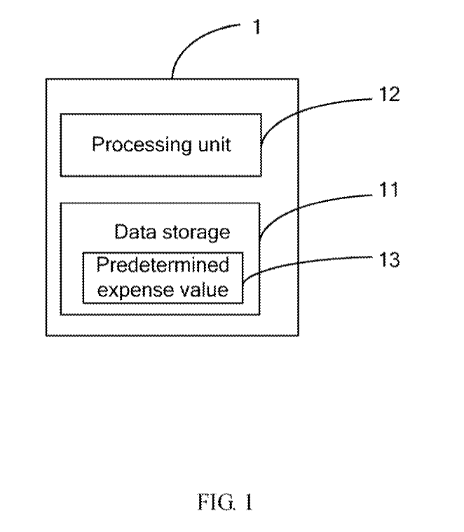

FIG. 1 is a block diagram of a portable electronic device with a spending detecting function in accordance with a first exemplary embodiment. The portable electronic device 1 includes a data storage 11 and a processing unit 12. The data storage 11 stores a predetermined expense value 13. In the present embodiment, the portable electronic device 1 is a communication device, and the predetermined expense value 13 is an amount of money the user is permitted to pay.

The processing unit 12 detects a current expense of the portable electronic device 1 periodically or in a predetermined condition, and determines whether the current expense of the portable electronic device 1 is greater than the predetermined expense value 13 stored in the data storage 11. In the present embodiment, the predetermined condition is when the portable electronic device 1 is used to pay a bill, such as a call fee, a network fee, or a supermarket bill. The processing unit 12 prompts the user to input a password if the current expense is greater than the predetermined expense value 13. The processing unit 12 forbids the portable electronic device 1 to pay the current expense if the input password does not match the predetermined password. The processing unit 12 executes the payment of current expense if the input password matches the predetermined password.

For example, supposing that the current expense is 20 $, when detecting the current expense that the portable electronic device 1 is to pay is greater than 20$, the processing unit 12 prompts the user to input the password. If the input password does not match with a predetermined password, the processing unit 12 prevents the portable electronic device 1 from paying the current expense. In the present embodiment, if the portable electronic device 1 is a communication device. The portable electronic device 1 further includes a SIM card, and the processing unit 12 is configured to send a signal to a server to lock the SIM card of the portable electronic device 1 to prevent the portable electronic device from paying the current expense.

In another embodiment, it is unnecessary for the processing unit 12 to prompt the user to input a password. Namely, the processing unit 12 forbids the portable electronic device 1 to pay the current expense if the current expense is greater than the predetermined expense value 13, and executes the payment of current expense if the current expense is not greater than the predetermined expense value 13.

In a second exemplary embodiment, the portable electronic device 1 includes a number of predetermined functions, and each of the predetermined functions is preset a predetermined expense value 13. When a function of the portable electronic device 1 is started, the processing unit 12 determines whether the started function is one of the predetermined functions. When the started function is the predetermined function, the processing unit 12 detects the current expense of the started function. If the current expense of the started function is greater than the predetermined expense value of the started function, the processing unit prompts the user to input a password, if the input password does not match the predetermined password, the started function is prevented. If the input password matches the predetermined password, the started function continues.

In this exemplary embodiment, if the predetermined function is a call function or network function, the predetermined expense value is the fee generated when the predetermined function is used. Furthermore, if the predetermined function is the call function, the predetermined expense value is dependent on the call time. If the predetermined function is the network function, the predetermined expense value is dependent on data flow between the portable electronic device 1 and the network.

In another embodiment, it is unnecessary for the processing unit 12 to prompt the user to input a password. Namely, the processing unit 12 prevents the started function if the current expense of the started function is greater than the predetermined expense value of the started function, and continues the started function if the current expense is not greater than the predetermined expense value 13.

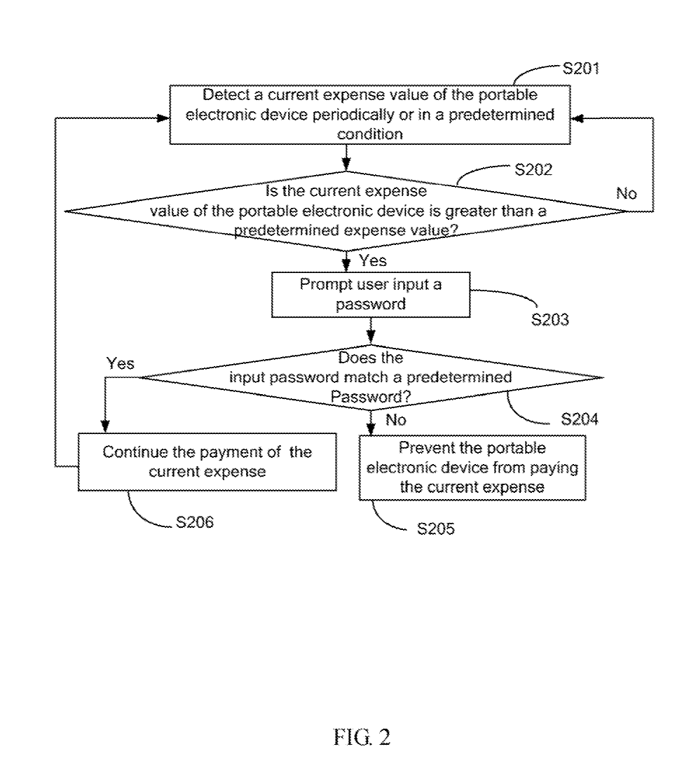

FIG. 2 is a flow chart of a use detecting method applied to the portable electronic device 1 as shown in FIG. 1, in accordance with a first exemplary embodiment. In step S201, the processing unit 12 detects a current expense of the portable electronic device 1 periodically or in a predetermined condition.

In step S202, the processing unit 23 determines whether the current expense of the portable electronic device 1 is greater than the predetermined expense value 13. If the current expense of the portable electronic device 1 is not greater than the predetermined expense value 13, the step goes to S201.

In step S203, the processing unit 12 prompts user input a password if the current expense is greater than the predetermined expense value 13.

In step S204, the processing unit 12 determines whether the input password matches a predetermined password.

In step S205, the processing unit 12 prevents the portable electronic device 1 from paying the current expense if the input password does not match the predetermined password.

In step S206, the processing unit 12 executes the payment of the current expense if the input password is not greater than the predetermined password.

In other embodiment, the steps S203 and S204 are unnecessary to implement. The step S205 is implemented if the current expense of the portable electronic device 1 is greater than the predetermined expense value 13, and the step S206 is implemented if the current expense of the portable electronic device 1 is not greater than the predetermined expense value 13.

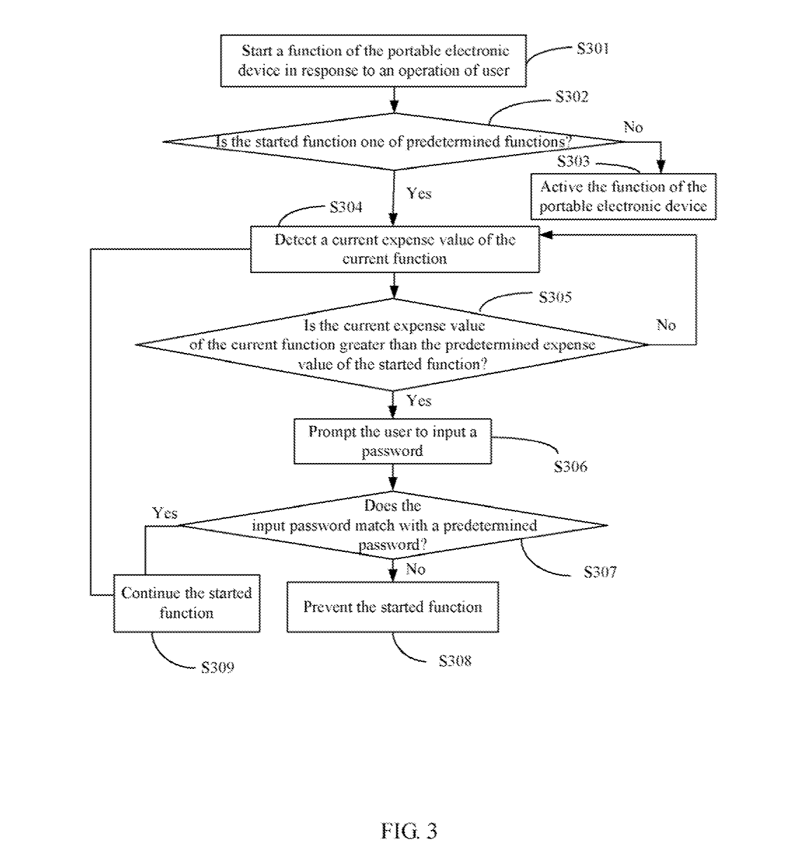

FIG. 3 is a flow chart of a use detecting method applied to the portable electronic device 1 as shown in FIG. 1, in accordance with a second exemplary embodiment.

In step S301, the processing unit 12 starts a function of the portable electronic device 1 in response to an operation of user.

In step S302, the processing unit 12 determines whether the started function is one of the predetermined functions.

In step S303, the processing unit 12 actives the function of the portable electronic device 1 if the started function is not the predetermined function.

In step S304, the processing unit 12 detects the current expense of the current function if the started function is the predetermined function.

In step S305, the processing unit 12 determines whether the current expense of the current function is greater than the predetermined expense value of the started function.

In step S306, the processing unit 12 prompts the user to input a password if the current expense of the started function is greater than the predetermined expense value of the started function.

In step S307, the processing unit 12 determines whether the input password matches with a predetermined password.

In step S308, the processing unit prevents the started function if the input password does not match the predetermined password.

In step S309, the processing unit 12 continues the started function if the input password matches the predetermined password.

In other embodiment, the steps S306 and S307 are unnecessary to implement. The step S308 is implemented if the current expense of the started function is greater than the predetermined expense value of the started function, and the step S309 is implemented if the current expense of the started function is not greater than the predetermined expense value of the started function.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A portable electronic device with a spending detecting function comprising:
a data storage for storing a predetermined expense value;
a processing unit for detecting a current expense of the portable electronic device periodically or in a predetermined condition, determining whether the current expense of the portable electronic device is greater than the predetermined expense value stored in the data storage, and preventing the portable electronic device from paying the current expense if the current expense of the portable electronic device is greater than the at least one predetermined expense value stored in the data storage.

2. The portable electronic device as described in claim 1, wherein the portable electronic device is a communication device.

3. The portable electronic device as described in claim 2, wherein the portable electronic device includes a SIM card, the processing unit prevents the portable electronic device from paying the current expense by sending a signal to a server to lock the SIM card.

4. The portable electronic device as described in claim 1, wherein the predetermined expense value is an amount of money the user is permitted to pay.

5. The portable electronic device as described in claim 1, wherein the predetermined condition is when the portable electronic device is used to pay bill.

6. The portable electronic device as described in claim 1, wherein the processing unit prompts user input a password if the current expense is greater than the predetermined expense value, prevents the portable electronic device from paying the current expense if the input password does not match the predetermined password, and continues the function which produces the current expense if the input password matches the predetermined password.

7. A portable electronic device with a plurality of predetermined function, comprising:
a data storage for storing a predetermined expense value for each predetermined function of the portable electronic device;
a processing unit for starting a function of the electronic device in response to an operation of use, determining whether the started function is one of the predetermined functions; detecting a current expense of the started function; determining whether the current expense of the started function is greater than the predetermined expense value of the started function; preventing the started function if the current expense of the started function is greater than the predetermined expense value of the started function.

8. The portable electronic device as described in claim 7, wherein the portable electronic device is a communication device.

9. The portable electronic device as described in claim 7, wherein the predetermined expense value is an amount of money the user is permitted to pay.

10. The portable electronic device as described in claim 7, wherein the predetermined condition is when the portable electronic device is used to pay bill.

11. The portable electronic device as described in claim 7, wherein the processing unit prompts user input a password if the current expense is greater than the predetermined expense value of the started function, prevents the started function if the input password does not match the predetermined password, and continues the started function if the input password matches the predetermined password.

12. The portable electronic device as described in claim 7, wherein if the predetermined function is a call function or network function, the predetermined expense value is the bill generated when the predetermined function is used.

13. The portable electronic device as described in claim 7, wherein if the predetermined function is a call function, the predetermined expense value is dependent on the call time.

14. The portable electronic device as described in claim 7, wherein if the predetermined function is a network function, the predetermined expense value is dependent on data flow between the portable electronic device and a network.

15. A spending detecting method applied to a portable electronic device, the portable electronic device storing a predetermined expense value, the method comprising:
detecting a current expense of the portable electronic device periodically or under a predetermined condition;
determining whether the current expense of the portable electronic device is greater than the predetermined expense value stored in the data storage;
preventing the portable electronic device from paying the current expense if the current expense of the portable electronic device is greater than the predetermined expense value stored in the data storage.

16. The method as described in claim 15, wherein the portable electronic device includes a SIM card, the way for preventing the portable electronic device to pay the current expense is sending a signal to a server to lock the SIM card.

17. The method as described in claim 15, wherein the predetermined expense value is an amount of money the user is permitted to pay.

18. The method as described in claim 15, wherein the predetermined condition is when the portable electronic device is used to pay bill.

19. The method as described in claim 15, further comprising: prompting user input a password if the current expense is greater than the predetermined expense value, preventing the portable electronic device from paying the current expense if the input password does not match the predetermined password, and continuing the payment of the current expense if the input password matches the predetermined password.
